(19) United States
(12) Patent Application Publication
(10) Pub. No.: US 2014/0238266 A1
(43) Pub. Date: Aug. 28, 2014

(54) Binder for manufacturing of concrete or laminated products

(71) Applicant: Max Canti, Gradara (PS) (IT)

(72) Inventor: Max Canti, Gradara (PS) (IT)

(21) Appl. No.: 14/347,043

(22) PCT Filed: Sep. 26, 2012
(86) PCT No.: PCT/IB2012/055117

§ 371 Date: Mar. 25, 2014

(30) Foreign Application Priority Data
Sep. 26, 2011 (IT) MO2011A000244

(51) Int. Cl. C08K 3/22; C08K 3/30; C08K 3/16

(52) U.S. Cl. CPC C08K 3/22; C08K 3/16; C08K 3/30; C08K 2003/222; C08K 2003/166; C08K 2003/3063
USPC 106/134.1; 106/157.5; 106/157.6; 106/137.1

(57) ABSTRACT

A binder for forming particle-based or laminated products includes a mixture of at least three components A, B, C, a first component A including a natural protein powder, a second component B including a magnesium oxide, and a third component C including a magnesium chloride or magnesium sulfate solution at 32° Bè (15° C.), or a free combination of both.

### FIELD OF THE INVENTION

The invention relates to a binder for forming particle-based or laminated products.

### BACKGROUND ART

In the fabrication of particle-based or laminated products, binders are known to be used for binding together wood particles to form particle boards and panels, MDFs, plywood panels, oriented strand boards, blockboards, etc., containing urea-formaldehyde, phenol-formaldehyde, melamine-formaldehyde.

These materials bind the particles or layers to be laminated, when the particle-based products obtained using the above materials are subjected to the combined actions of pressure and heat.

Alternatively, a two-component polyurethane binder is known to be used, which may spontaneously cure at room temperature or undergo accelerated curing by being subjected to the action of microwaves or radio-frequency, when it is already laminated but has not been pressed yet, with the laminated assembly being later subjected to a pressure action.

Generally, these binders are substantially divided into two classes, namely a class comprising those that form non-water resistant particle-based or laminated products and a class designed for water-resistant products.

The latter include the most widely used binders, phenol-formaldehyde and melamine-formaldehyde.

In addition, two-component or one-component polyurethane (diisocyanate) may be used, which is water-resistant but is less used for cost reasons.

The two- or one-component polyurethane uses as a second component the residual moisture contained in the wood to be bound and the one absorbed from air in the open steps of mixing and laminating the assembly to be pressed.

Non-water resistant binders are urea-formaldehyde and vinyl adhesives: the latter are less used due to their easy reversibility with moisture.

A further discrimination in the use of binders is given by cost, and according to this parameter the less expensive binder is urea-formaldehyde, which is the most widely used for making interior furniture panels.

Conversely, those that ensure high water resistance have a very high cost, and include melamine-formaldehyde, phenol-formaldehyde, two-and one-component polyurethane.

The binders used in combination with formaldehyde, which is known to be a carcinogenic material, give off free formaldehyde, because the latter, in addition to being naturally contained in tree wood, is used in excess amounts for quicker curing of binders, to improve throughput at each production site.

The binders combined with two-component polyurethane, in addition to their above mentioned high cost, are dangerous, in case of fire or upon disposal by burning, at the end of their life, because at a combustion temperature of 500° C. and more, they generate cyanide, a highly poisonous and paralyzing substance.

In prior art, no significant progress has been achieved for some time, and all the particle-based products derived from current industrial processes are mainly manufactured using formaldehyde as a binder.

For example, in the manufacture of decorative high-pressure plastic laminates, the thicker substrate is formed using multiple sheets of Kraft paper impregnated with phenol-formaldehyde, and the decorative surface layer is formed by interleaving first a barrier sheet, to prevent color alteration by phenol, and then a decorative paper sheet, having a single color or printed generally with wood texture, impregnated with melamine-formaldehyde.

In prior art low-pressure laminates are also used, which are formed in continuous rolls.

In practice, these low-pressure laminate products are made of paper impregnated of melamine-formaldehyde.

In order to make other particle-based or laminated products in which no wood or paper is used, such as stone conglomerates, binders are used that comprise polyester resins in combination with styrene monomer, or acrylic resins.

Here again, polyester resins combined with styrene monomer are the most widely used binders, for their lower cost, in spite of their considerable environmental impact caused by styrene emissions, with styrene being used in amounts exceeding stoichiometric amounts, to be combined with polyester for fluidizing and carrying the binder in the mixture.

Styrene monomer is also known to be at least as carcinogenic as benzene.

### OBJECTS OF THE INVENTION

One object of the invention is to provide a novel non-toxic binder, that has no emissions and no toxicity, is also resistant to weather and to long heat-stress treatments, such as boiling, has a low cost, as a non-oil derivative, and is also environment-friendly, because the products obtained using the inventive binder may be ground to powder for end-of-life disposal and spread on the fields as a fertilizer or a mineral supplement for crops.

The binder of the invention may be a substitute for prior art water-resistant binders, although it has a low cost, similar to that of urea-formaldehyde, while differing from the latter for its lack of toxicity and its considerably better physical and mechanical properties.

A further object is to use the binder of the invention as a replacement for binders for stone aggregates.

Another object is to use the binder of the invention to make fire barrier panels, for instance as a replacement for rock wool panels with fibers bound by phenol-formaldehyde, that are used, for instance in shipbuilding in which, due to vibrations, they tend to pulverize and to leave the top of the panel exposed, and hence allow fire to spread and represent a considerable hazard during demolition, due to its suspected carcinogenicity, substantially similar to that of asbestos.

A further object is to use the binder of the invention to make insulating plasters, by mixing it with sand and other expanded inorganic inert materials, such as pearlite, pumice, vermiculite, expanded porous glass, cellites.

Another object is to use the binder of the invention to form stone aggregates containing quartz, recycled glass, grog (i.e. ceramic fragments and powders), marble.

Yet another object is to use the binder of the invention at least in the support layers of decorative plastic laminates, to reduce the free formaldehyde content thereof.

A further object is to use the binder of the invention to make plywood and laminate elements, formed from wood sheets such as, without limitation, those used in the fabrication of specially shaped seats for chairs, that are designed to be upholstered and in which, due to the large number of adhesive layers required for seat lamination, the carcinogenic free formaldehyde is present in amounts that can hardly meet the regulatory limits.

In one aspect the invention relates to a binder for making particle-based or laminated products as defined in the features of claim 1.

Therefore, the invention affords the following advantages:

providing a binder that can be quickly heated even using microwave or radio-frequency heating devices;

providing a binder that has no emissions and no toxicity, is also resistant to weather and to long heat-stress treatments, such as boiling, has a low cost, and is a non-oil derivative and hence is environment-friendly,

providing particle-based or laminated products that may be ground to powder for end-of-life disposal and spread on the fields as fertilizers or mineral supplements for crops;

replacing prior art water-resistant binders, at a low cost, similar to that of urea-formaldehyde, while affording lack of toxicity and considerably better physical and mechanical properties;

providing a binder that can be used for binding and laminating stone aggregates;

obtaining particle-based or laminated products in the form of safe, non-carcinogenic fire barrier panels;

providing a binder that can be used to make insulating plasters, by mixing it with sand and other expanded inorganic inert materials, such as pearlite, pumice, vermiculite, expanded porous glass, cellites;

providing a binder that can be used for form stone agglomerates or laminates containing quartz, recycled glass, grog, marble;

providing a binder that can be used in the support layers of decorative plastic laminates, to reduce the free formaldehyde content thereof;

obtaining plywood and laminate elements formed from wood sheets, without using the carcinogenic free formaldehyde.

### BRIEF DESCRIPTION OF THE FIGURES

Further characteristics and advantages of the invention will be more apparent upon reading of the description of an embodiment of a binder for making particle-based or laminated products, as shown by way of example and without limitation in the annexed pictures, which are obtained using the scanning electron microscope Philips SEM XL20, wherein:

FIG. 1 is a view of a microstructure of a traditional soy-free binder, at 50× magnification;

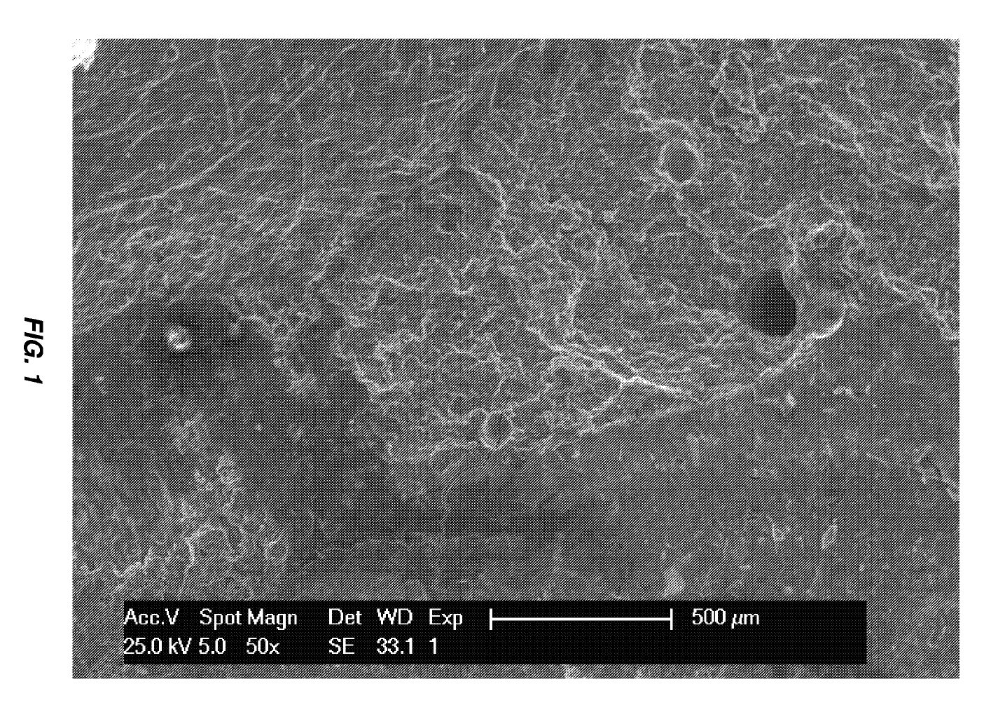

FIG. 2 is a view of the microstructure of FIG. 1, at 100× magnification;

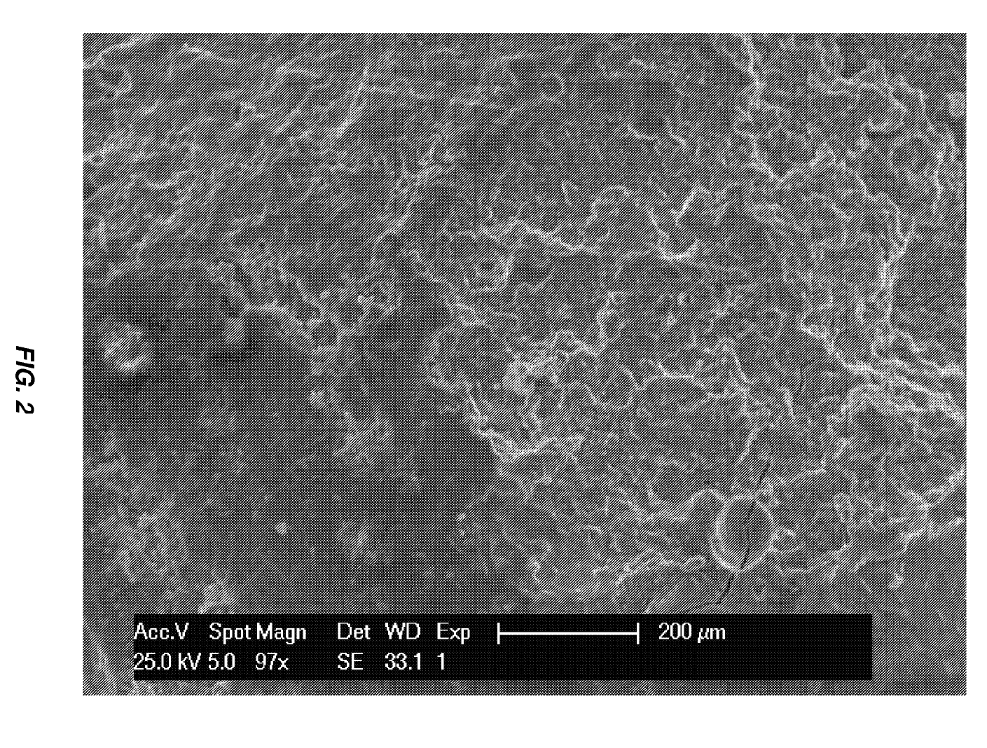

FIG. 3 is a view of a microstructure of a binder of the invention, containing 25% soy, at 50× magnification;

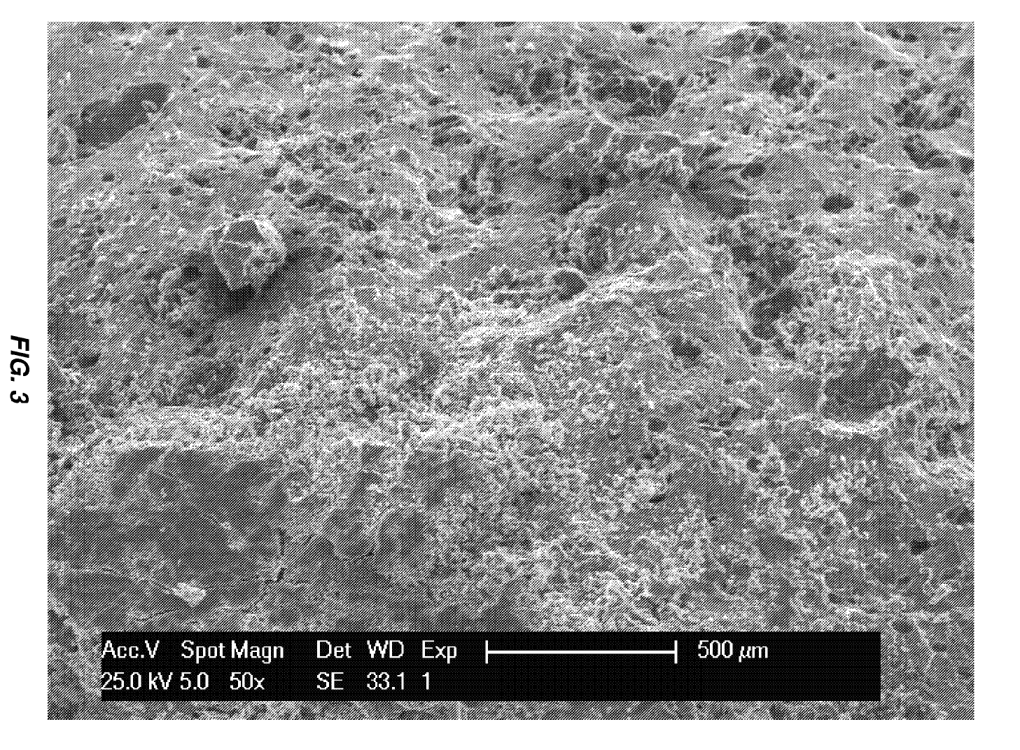

FIG. 4 is a view of the microstructure of FIG. 3, at 100× magnification;

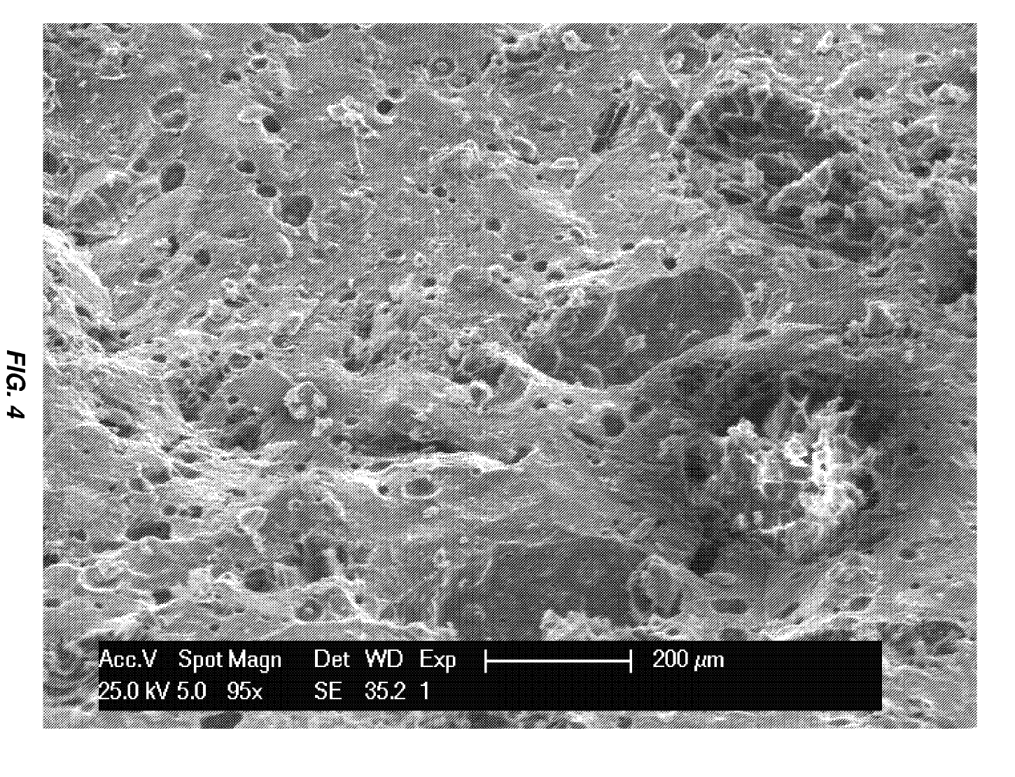

FIG. 5 is a view of a microstructure of a binder of the invention, containing 50% soy, at 50× magnification;

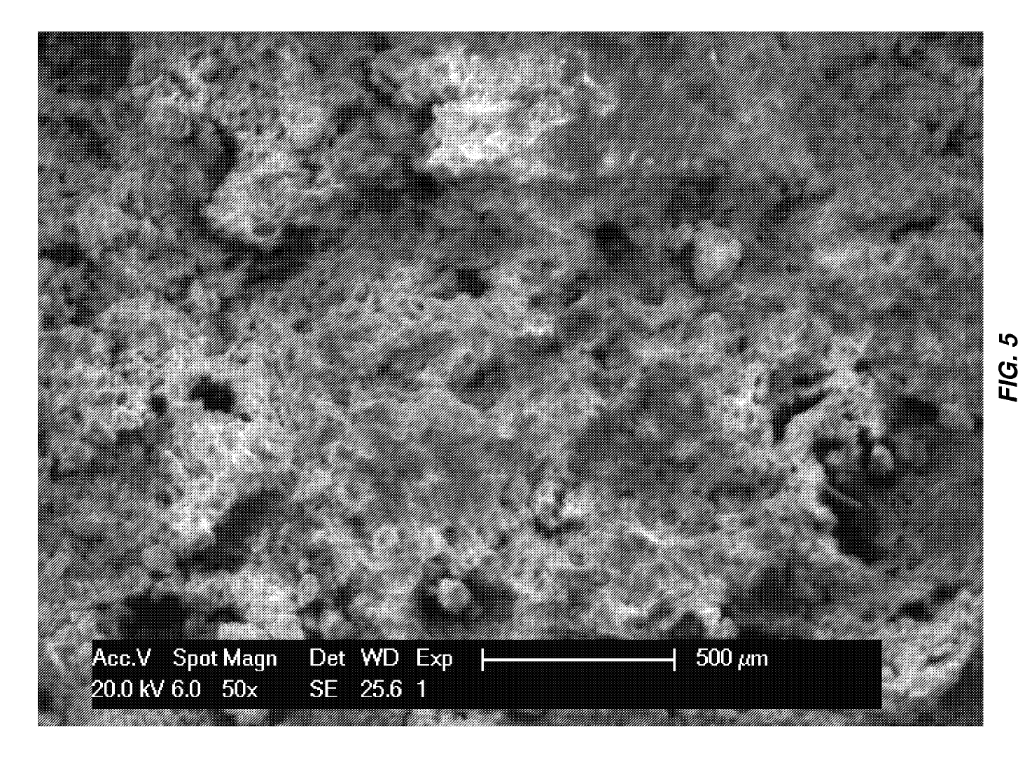

FIG. 6 is a view of the microstructure of FIG. 5, at 100× magnification;

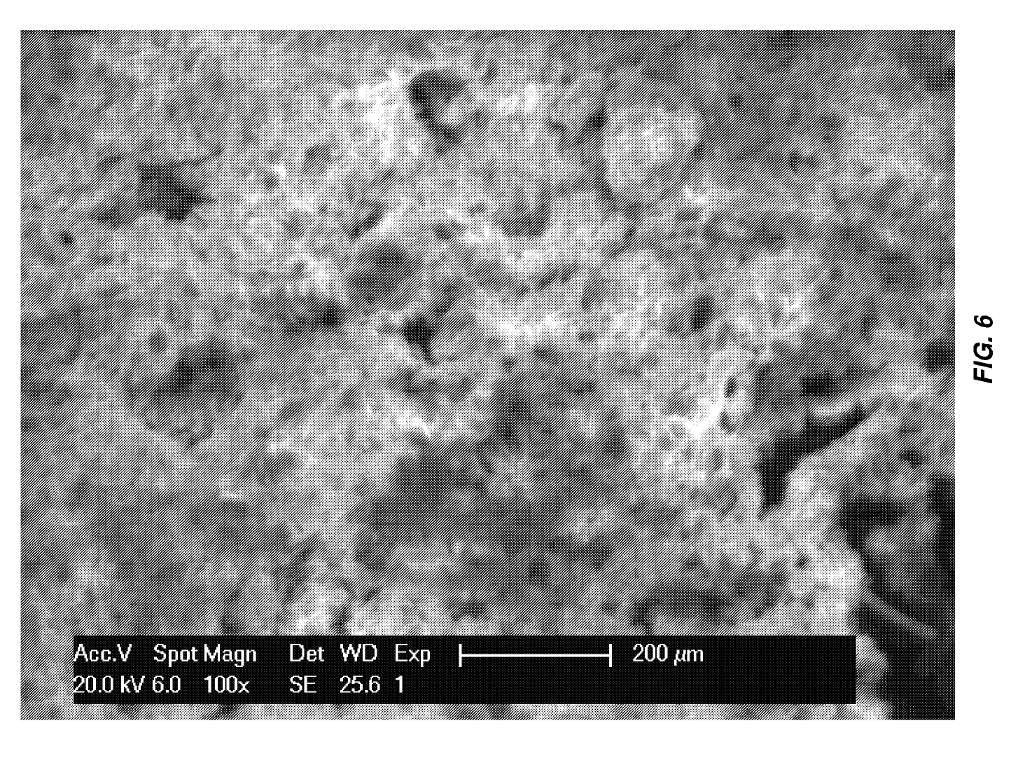

FIG. 7 is a view of a microstructure of a binder of the invention, containing 75% soy, at 50× magnification;

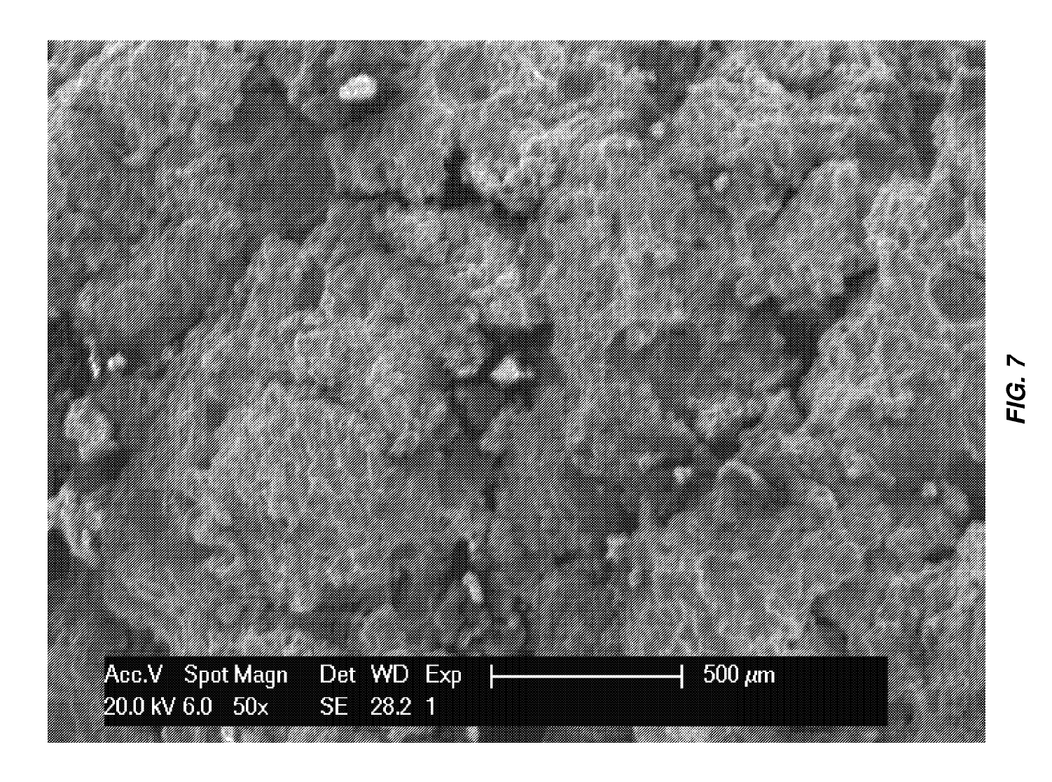

FIG. 8 is a view of the microstructure of FIG. 7, at 100× magnification.

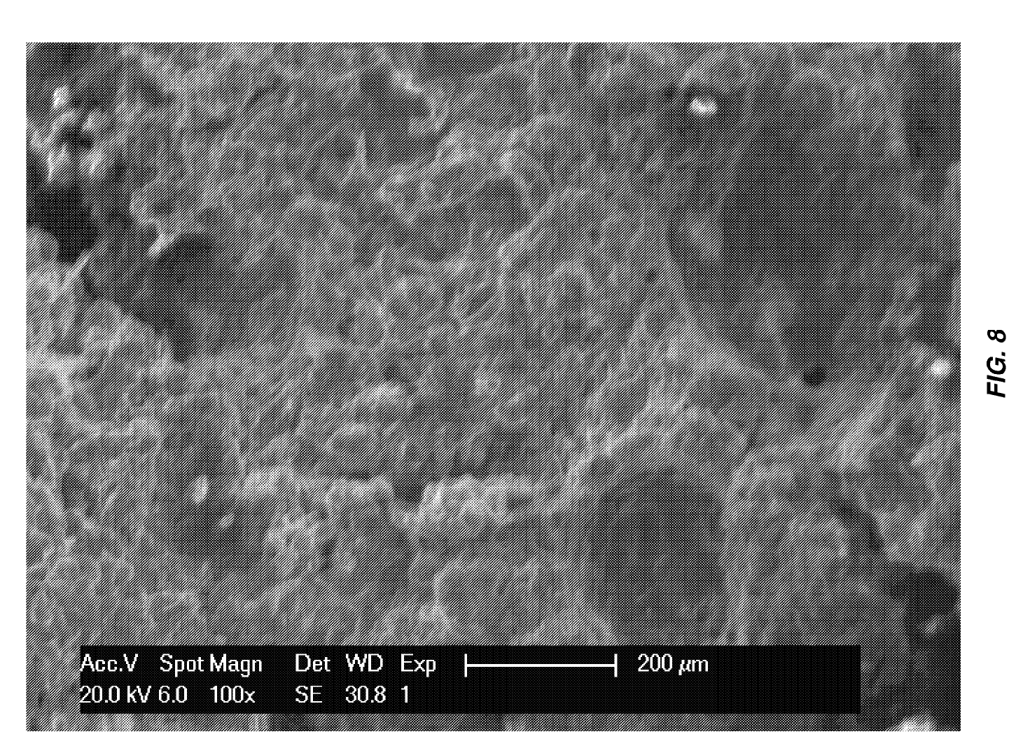

### DETAILED DESCRIPTION OF A PREFERRED EMBODIMENT

The binder is obtained by mixing different amounts of at least three components, briefly designated by A, B, C hereinafter.

The component A comprises a natural protein powder which, in the pictures herein, is a soybean flour, whereas the component B comprises magnesium oxide and the component C comprises a magnesium chloride or magnesium sulfate solution at 32° Bè (15° C.), or a free combination of both.

A water amount is later added to the mixture of these components A, B, C, for fluidizing the binder.

For optimized efficiency in the fabrication of the binder of the invention, a minimized amount of water should be added to the mixture of the components A, B, C, to avoid the energy consumption required for eliminating it from the particle-based or laminated products so obtained.

Preferably the ratio of the component B and the solution C by weight is 1:1.

Nevertheless ratios may be also envisaged having a smaller amount of the component C.

The component B will be referred to hereinafter, for simplicity, as involving the presence of the component C in the ratio as mentioned above.

In a first embodiment, this binder of the invention may afford rigid binding, and provide particle-based or laminated products that are resistant to fire and prolonged boiling.

In this embodiment, the component B is largely prevalent in the binder mixture, as it falls in the range from 70% to 95%, whereas the component A falls in a range from 5% to 30%.

In a second possible embodiment, the binder of the invention affords more flexible binding, having a higher bending rupture strength.

In this second embodiment, the relative amounts of the components A and B are substantially reversed as compared with the previous embodiment, with the component A falling in a range from 70% to 95%, and the component B falling in a range from 5% to 30%.

In this second embodiment, the binder provides particle-based or laminated products that ensure water resistance, but are not fire proof.

A third embodiment of the binder of the invention may be also provided, that can form particle-based or laminated products having features and performances in-between those of the two previous embodiments, with combinations of amounts for the components A and B in ratios of 69% component A and 31% component B, to a gradually reversed ratio.

According to the invention, mixtures may be also provided in which the amount of the component A or the component B is lower than 5%, and in any case the mixture of the components that form the binder of the invention always involves the presence of the three components A, B, C, and the above mentioned ratio of the component B to the component C, i.e. one part of the component B and one part, or a little less, of thee component C.

The soybean flour in the component A may be also replaced, according to the invention, with other vegetable powders containing a high protein content, such as horse bean flours or other leguminous flours, or animal flours, such as acid casein.

It shall be noted that the binder of the invention should be prepared substantially at the time of use, as it also cures at room temperature, within about 24 hours.

Such preparation should occur by first mixing together magnesium oxide and soybean flour powders, and then hydrating the mixture obtained with the component C, i.e. the magnesium chloride or magnesium sulfate solution at 32° Bé (15° C.), or a free combination of both in the above mentioned ratios, and by adding water to an amount that can form a fluid, free-flowing and sprayable paste.

If an excess amount of the component A, i.e. the soybean flour, is provided during preparation of the mixture of components, there may be added small amounts of copper sulfate or carbon sulfide or magnesium or zinc or aluminum fluorosilicate, aluminum sulfate or other animal-safe antiseptic products.

The fluidized binder so obtained may be added to the particles to be bound in mixers, or sprayed into an airstream that carries a known amount of particles, when the latter have a light weight, like in the case of wood chips or fiber flakes.

The fluid binder may be also spread on the layers to be laminated to obtain plywood or laminates, using a metering roller.

The fluid binder may be coated, for instance, by dipping the paper to be impregnated or the peeled wood sheets to form laminated products and by straining it between two pressure rollers.

The above disclosed invention was found to fulfill the intended objects.

The invention is susceptible to a number of changes and variants within the inventive concept.

Furthermore, all the details may be replaced by other technically equivalent parts.

In practice, any materials, shapes and sizes may be used as needed, without departure from the scope of the following claims.

1. A binder for manufacturing concrete or stratified products comprising:
a mixture of at least three components A, B, and C,
a first component A comprising a natural protein flour, a second component B comprising a magnesium oxide, a third component C comprising a solution of magnesium chloride or magnesium sulphate at 32° Bè (at 15° C.), or a combination thereof.

2. The binder according to claim 1, wherein said natural protein flour comprises a soy flour.

3. The binder according to claim 1, wherein said natural protein flour is chosen among a broad bean flour, a pulse flour, a flour of animal provenance, or a flour of acid casein.

4. The binder according to claim 1, wherein a ratio between said components B and C is substantially 1:1.

5. The binder according to claim 1, wherein in said mixture said component C is slightly lower than said component B.

6. The binder according to claim 1, wherein said mixture further comprises one or both of a hydrating or fluidifying liquid.

7. The binder according to claim 1, wherein said mixture comprises from 95% down to 70% of said component A and from 5% up to 30% of said component B.

8. The binder according to claim 1, wherein said mixture comprises from 75% down to 65% of said component A and from 25% up to 35% of said component B.

9. A product obtained with a binder according to claim 1, wherein said product is in the form of a concrete or a rigid mat comprising bound particles of materials selected from the group consisting of direct or derived wood materials, natural fibers of agricultural origin, inorganic materials, glass materials, stone materials, or ceramic materials.
